(19) United States
(12) Patent Application Publication
(10) Pub. No.: US 2020/0379566 A1
(43) Pub. Date: Dec. 3, 2020

(54) OPERATION VIBRATION APPARATUS, IMAGE FORMING APPARATUS AND RECORDING MEDIUM

(71) Applicant: KONICA MINOLTA, INC., Tokyo (JP)

(72) Inventor: Hisataka FUNAKAWA, Tokyo (JP)

(73) Assignee: KONICA MINOLTA, INC., Tokyo (JP)

(21) Appl. No.: 16/857,229

(22) Filed: Apr. 24, 2020

(30) Foreign Application Priority Data
May 28, 2019 (JP) 2019-099037

(51) Int. Cl. G06F 3/01; G03G 15/00; G06F 3/041

(52) U.S. Cl. CPC G06F 3/016; G06F 3/0412; G03G 15/5016

(57) ABSTRACT

Provided is an operation vibration apparatus that includes: an operator including an operation panel that receives touch input, and a fixer that fixes the operation panel to a housing as an installation target; a vibrator that vibrates the operation panel; and a hardware processor that controls the vibrator according to drive information regarding intensity of drive to make intensity of vibration of the operation panel uniform by corresponding to the fixer, when there is operation input made on the operator.

### CROSS-REFERENCE TO RELATED APPLICATIONS

The entire disclosure of Japanese Patent Application No. 2019-099037 filed on May 28, 2019 is incorporated herein by reference in its entirety.

### BACKGROUND

### Technological Field

The present invention relates to an operation vibration apparatus, an image forming apparatus and a recording medium.

### Description of Related Art

Conventionally, image forming apparatuses such as a printer that forms electrophotographic images on sheets as recording media, an MEP (Multifunction Peripheral), and the like are known.

Further, in recent years, there have been increasing mobile devices such as smartphones that provide a notification by vibration as a response to an operation made on a touch panel or the like. There is a demand also for the image forming apparatuses to vibrate an operator (operation panel) including a touch panel.

However, because the mobile device is used by being held in a hand, vibration as a response to an operation may simply be transmitted uniformly to the holding hand regardless of push positions on a touch panel. Therefore, it is designed such that the back face of the mobile device near the holding hand vibrates strongly.

The image forming apparatus is a device that is not used by being held in a hand and, for giving a response with vibration on an operation panel, it is necessary to uniformly vibrate an operation area to be operated on the operation panel for transmitting the vibration to the operating fingertip. Therefore, it is necessary to take a measure such as disposing a vibrator at the center of the back face of a movable component including the operation panel and peripherals.

Further, there is known a tactile sensation presentation apparatus that detects a pushed amount by changing a detection threshold value according to a push position of a touch sensor, and gives a vibration response with a uniform-force pressure regardless of the push positions (see JP No. 5658493)

### SUMMARY

The operation panel of the image forming apparatus is used in common for a plurality of types of apparatuses in many cases. Therefore, even when vibration responses are given with a uniform pressure within the operation panel as in the case of the tactile sensation presentation apparatus, the vibration intensity on the operation panel is changed when a fixer for fixing the operation panel varies.

The object of the present invention is to uniformly vibrate the operation panel regardless of the configuration of the installed target such as the image forming apparatus.

To achieve at least one of the abovementioned objects, according to an aspect of the present invention, the operation vibration apparatus includes: an operator including an operation panel that receives touch input, and a fixer that fixes the operation panel to a housing as an installation target; a vibrator that vibrates the operation panel; and a hardware processor that controls the vibrator according to drive information regarding intensity of drive to make vibration of the operation panel uniform by corresponding to the fixer, when there is operation input made on the operator.

To achieve at least one of the abovementioned objects, according to another aspect of the present invention, the non-transitory computer readable recording medium stores a program for causing a computer to function as: an operator including an operation panel that receives touch input, and a fixer that fixes the operation panel to a housing as an installation target; a vibrator that vibrates the operation panel; and a hardware processor that controls the vibrator according to drive information regarding intensity of drive to make vibration of the operation panel uniform by corresponding to the fixer, when there is operation input made on the operator.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram showing a schematic configuration of an image forming apparatus according to an embodiment of the present invention;

FIG. 2 is a block diagram showing a functional configuration of the image forming apparatus;

FIG. 3A is a schematic diagram showing an operation displayer that is fixed firmly;

FIG. 3B is a chart showing vibration waveforms of each component of the operation displayer;

FIG. 4A is a schematic diagram showing an operation displayer that is fixed unfirmly;

FIG. 4B is a chart showing vibration waveforms of each component of the operation displayer;

FIG. 5A is a schematic diagram showing a fixed-type operation displayer provided to a housing;

FIG. 5B is a schematic diagram showing a tilt-type operation displayer provided to a housing;

FIG. 5C is a schematic diagram showing a slide-type operation displayer provided to a housing; and

FIG. 6 is a flowchart showing operation response processing.

### DETAILED DESCRIPTION OF THE EMBODIMENTS

Hereinafter, one or more embodiments of the present invention will be described with reference to the drawings. However, the scope of the invention is not limited to the disclosed embodiments.

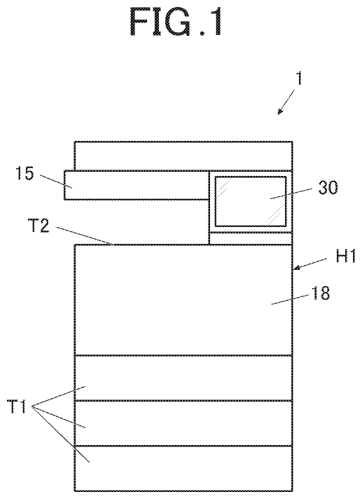

First, by referring to FIG. 1 to FIG. 5C, the configuration of an apparatus according to an embodiment will be described. First, by referring to FIG. 1, the entire configuration of an image forming apparatus 1 according to the embodiment will be described. FIG. 1 is a diagram showing a schematic configuration of the image forming apparatus 1 of the embodiment.

It is assumed that the image forming apparatus 1 of the embodiment is an MFP that forms color images with an electrophotographic method as an image forming method. However, the image forming apparatus is not limited thereto but may be any other image forming apparatuses such as an electrophotographic printer, an image forming apparatus of another image forming method such as an inkjet recording type, and an image forming apparatus that forms monochrome images.

As shown in FIG. 1, the image forming apparatus 1 includes a housing H1 as well as a plurality of feeder trays T1, an image reader 15, an operation displayer 30, an image former 18, an output tray T2, and the like provided inside and outside the housing H1.

Note that the image forming apparatus 1 represents those of a plurality of configurations. The plurality of configurations include different models of apparatuses and also cases of same models with different configurations changed because of repairs or the like. For example, the image forming apparatus 1 may be of a configuration with which the size or the like of the sheet on which the images can be formed varies depending on the models such as A3 machine or A4 machine, and may be of a configuration with different models or even with the same model in which the fixing structure of the operation displayer 30 varies.

The operation displayer 30 is a structure placed outside the housing H1, which receives touch input such as various kinds of settings of the image forming apparatus 1 made by a user on a touch panel and displays the operation screen and various kinds of display information such as setting contents. Further, the operation displayer 30 outputs an operation sound such as a buzzer sound for a response and provides vibration in response to the touch input made by the user. Further, since there is no sense of clicking felt at the time of operation on the touch panel, the operation sound is generated at the time of operation for helping recognize the operation input. However, the sound notification alone is insufficient, so that the part of the touch panel is vibrated to give vibration notification to the user.

The image forming apparatus 1 receives PDL (Page Description Language) data from a PC (Personal Computer) or the like as an external apparatus on a communication network, and generates bitmap-format image data by performing rasterization on the PDL data. Further, the image forming apparatus 1 reads out a document sheet by the image reader 15, and generates image data by performing image processing. The generated image data is image data of each of colors C (cyan), M (magenta), Y (yellow), and K (black).

The image forming apparatus 1 forms, by the image former 18, a toner image on the sheet fed from the feeder tray T1 based on the image data generated from the PDL data or the image data generated by the image reader 15, fixes the image on the sheet, and discharges the fixed sheet to the output tray T2.

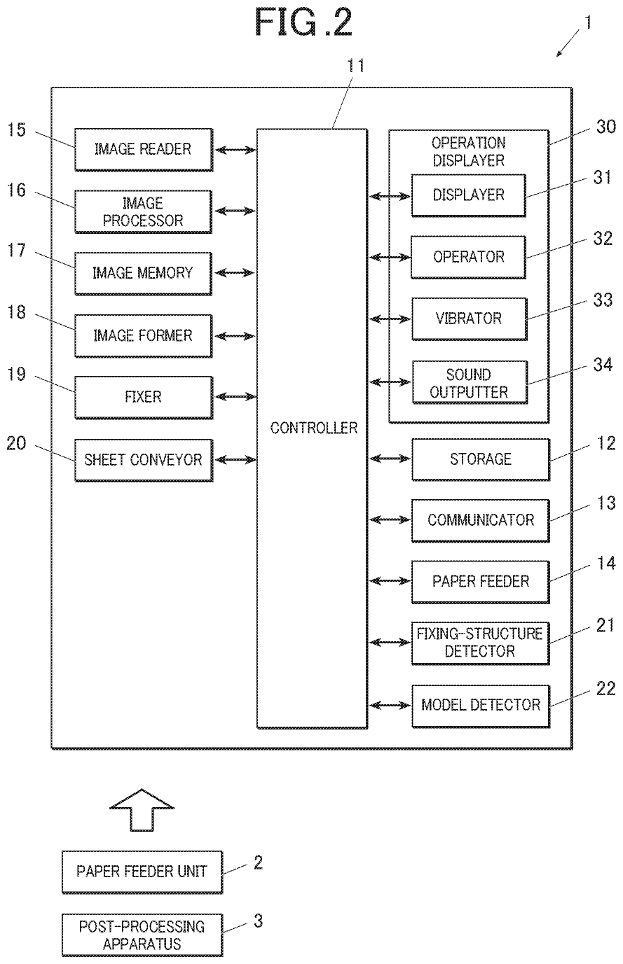

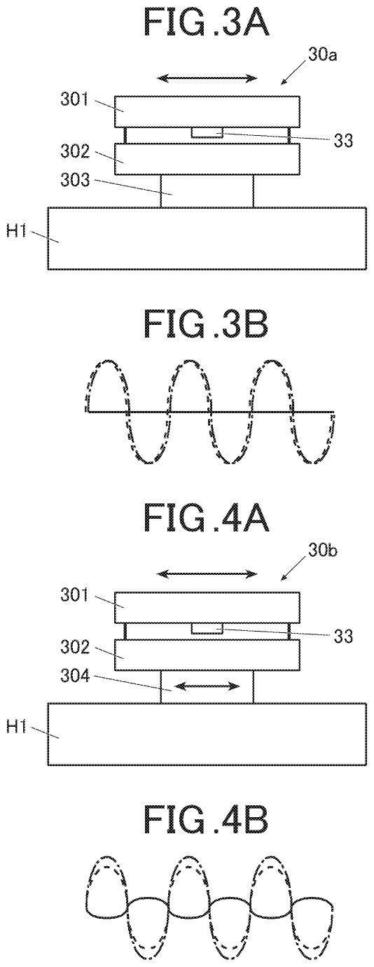

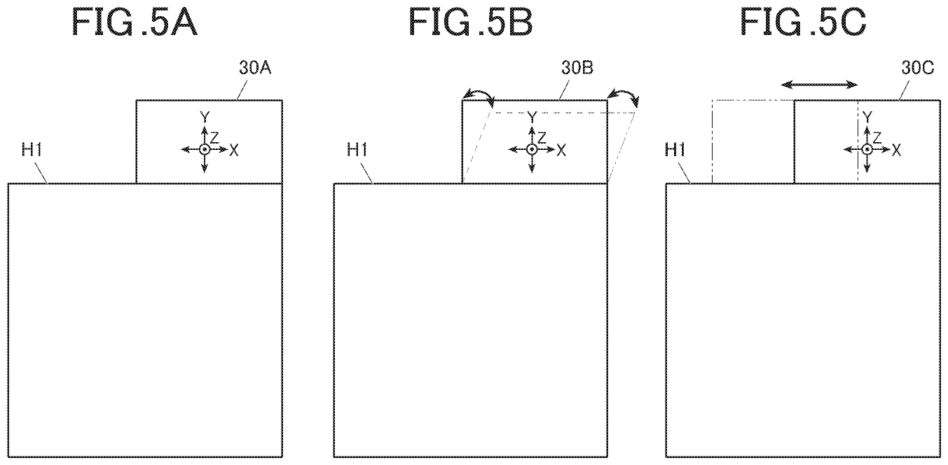

Subsequently, by referring to FIG. 2 to FIG. 5C, the functional configuration of the image forming apparatus 1 will be described. FIG. 2 is a block diagram showing the functional configuration of the image forming apparatus 1. FIG. 3A is a schematic diagram showing an operation displayer 30a that is fixed firmly. FIG. 3B is a chart showing vibration waveforms of each component of the operation displayer 30a. FIG. 4A is a schematic diagram showing an operation displayer 30b that is fixed unfirmly. FIG. 4B is a chart showing vibration waveforms of each component of the operation displayer 30b. FIG. 5A is a schematic diagram showing a fixed-type operation displayer 30A provided to the housing H1. FIG. 5B is a schematic diagram showing a tilt-type operation displayer 30B provided to the housing H1. FIG. 5C is a schematic diagram showing a slide-type operation displayer 30C provided to the housing H1.

As shown in FIG. 2, the image forming apparatus 1 includes a controller 11 (hardware processor), the operation displayer 30 as an operator, a storage 12 as a storage, a communicator 13, a paper feeder 14, the image reader 15, an image processor 16, an image memory 17, the image former 18 as an image former, a fixer 19, a sheet conveyor 20, a fixing-structure detector 21 as a fixing structure acquirer, and a model detector 22 as a model acquirer. The operation displayer 30 includes a displayer 31, an operator 32, a vibrator 33 as a vibrator, and a sound outputter 34. The controller 11 and the operation displayer 30 function as an operation vibration apparatus.

The controller 11 includes a CPU (Central Control Unit), a RAM (Random Access Memory), and the like. The CPU of the controller 11 reads out and expands a program stored in the storage 12 on the RAM, and controls each component of the image forming apparatus 1 according to the expanded program. For example, the controller 11 acquires image data inputted from outside via the communicator 13 or image data read out via the image reader 15 according to operation information from the user inputted via the operator 32, and executes image forming processing with which image processing is performed on the image data of a job by the image processor 16, a sheet is fed by the paper feeder 14, an image is formed on the sheet by the image former 18 and fixed by the fixer 19, and the sheet is discharged to the output tray T2.

The displayer 31 includes a display panel such as an LCD (Liquid Crystal Display), and displays various kinds of display information such as the operation screen on the display panel under control of the controller 11. The operator 32 includes a touch panel configured integrally with the display panel of the displayer 31, and outputs operation signals according to touch input made by the user to the controller 11. Thus, the display panel of the displayer 31 is defined as an operation display panel as an operation panel. The operation display panel is attached to the housing H1 of the image forming apparatus as the installation target.

The vibrator 33 is disposed at the back face (for example, in the center of the back face) of the operation display panel of the displayer 31 that is integral with the operator 32. The vibrator 33 includes a vibration element that converts electric signals to physical vibration, and vibrates the vibration element under the control of the controller 11 to vibrate the operation display panel of the displayer 31 and the finger of the user touching it. Further, because most of the typical vibration elements vibrates in one direction, the vibrator 33 includes three vibration elements disposed to vibrate in each of directions of three axes that are X-axis and Y-axis of a two-dimensional plane (XY plane) of the operation display panel of the displayer 31 and in Z-axis that is perpendicular to the X-axis and the Y-axis, for example. The vibrator 33 selects and vibrates at least one vibration element among the three vibration elements under the control of the controller 11.

Note that the vibrator 33 may be configured to have a mechanism capable of changing the vibrating direction of one vibration element of the operation display panel of the displayer 31 to change the vibrating direction of the vibration element under the control of the controller 11. Further, the vibrator 33 may be configured to be capable of changing the vibrating direction of one vibration element of the vibrator 33 manually.

The sound outputter 34 includes an amplifier, a speaker, and the like, and outputs an operation sound such as a buzzer sound under the control of the controller 11.

By referring to FIG. 3A and FIG. 3B, the operation displayer 30a will be described herein as an example of the operation displayer 30. As shown in FIG. 3A, the operation displayer 30a is firmly fixed to the housing H1. The operation displayer 30a includes a movable component 301, an unmovable component 302, a fixer 303, and the vibrator 33. The movable component 301 is a movable part of the operation displayer 30a, and includes the operation display panel of the displayer 31. The vibration elements of the vibrator 33 are attached to the back face of the movable component 301. The unmovable component 302 is a unmovable part of the operation displayer 30a. The fixer 303 is a fixer that is configured with a vibration absorbance material and firmly fixes the unmovable component 302 and the like to the housing H1.

In FIG. 3B, the vibration waveform of the vibrator 33 of the operation displayer 30a is shown with a long and short dash line, the vibration waveform of the movable component 301 is shown with a broken line, and the vibration waveform of the fixer 303 is shown with a solid line. As can be seen from each of the vibration waveforms shown in FIG. 3B, the movable component 301 of the operation displayer 30a vibrates without damping when the vibrator 33 is driven because the unmovable component 302 is fixed to the fixed housing H1 via the firm fixer 303.

As shown in FIG. 4A, the operation displayer 30b is unfirmly fixed to the housing H1. The operation displayer 30b includes the movable component 301, the unmovable component 302, a fixer 304, and the vibrator 33. The fixer 304 is a fixer that is configured with a vibration absorbance material and unfirmly fixes the unmovable component 302 and the like to the housing H1.

In FIG. 4B, the vibration waveform of the vibrator 33 of the operation displayer 30a is shown with a long and short dash line, the vibration waveform of the movable component 301 is shown with a broken line, and the vibration waveform of the fixer 304 is shown with a solid line. As can be seen from amplitudes of each of the vibration waveforms shown in FIG. 4B, the fixer 304 slightly vibrates because vibration generated on the housing H1 side when the vibrator 33 vibrates cannot be maintained. Therefore, the vibration intensity as the amplitude of the vibration waveform of the movable component 301 is damped compared to the vibration intensity of the vibrator 33.

As described, the vibration intensity of the operation display panel changes depending on the fixing firmness level of the fixer of the operation displayer 30. Therefore, by controlling the vibration drive according to the fixing firmness level, the vibration intensity can be maintained uniform regardless of the fixer.

Further, by referring to FIG. 5A, FIG. 5B, and FIG. 5C, examples of the operation displayer 30 with different types of movable structure will be described herein. As shown in FIG. 5A, the fixed-type operation displayer 30A as an example of the operation displayer 30 is fixed to the housing H1 via the unmovable fixer 303. The operation display panel of the operation displayer 30A is firmly fixed and held for all the directions of the X-axis direction, Y-axis direction, and Z-axis direction. Therefore, there is only little damping in vibration of the vibrator 33 in all directions.

As shown in FIG. 5B, the tilt-type operation displayer 30B as an example of the operation displayer 30 is fixed to the housing H1 via the movable fixer 304. The operation display panel of the operation displayer 30B is firmly fixed and held for the X-axis direction and the Y-axis direction, but held with weak fixation for the Z-axis direction because it is movable in the Z-axis direction. Therefore, damping in vibration can be suppressed when the vibrator 33 is vibrated in the X-axis direction or the Y-axis direction.

As shown in FIG. 5C, the slide-type operation displayer 30C as an example of the operation displayer 30 is fixed to the housing H1 via the movable fixer 304. The operation display panel of the operation displayer 30C is firmly fixed and held for the Y-axis direction and the Z-axis direction, but held with weak fixation for the X-axis direction because it is movable in the X-axis direction. Therefore, damping in vibration can be suppressed when the vibrator 33 is vibrated in the Y-axis direction or the Z-axis direction.

Returning to FIG. 2, the storage 12 stores programs, files, and the like that can be read out by the controller 11. As the storage 12, it is possible to use nonvolatile recording medium capable of reading and writing such as a hard disk and a flash memory, for example. Specifically, it is assumed that an image forming program for executing the image forming processing and an operation response program for executing operation response processing to be described later are stored in the storage 12.

Further, it is assumed that a drive information table is stored in the storage 12. The drive information table is a table stored at the factory setting, for example, and includes drive information of the vibrator 33 corresponding to model information of the image forming apparatus 1, fixing-structure type information of the operation displayer 30, and installation information. The model information is identification information regarding the models (for example, includes A3 machine or A4 machine indicating the sheets on which images can be formed) of the image forming apparatus 1. The fixing-structure information of the operation displayer 30 is information showing the fixing-structure type (fixed, tilt, or slide) of the operation display panel of the displayer 31 as the vibration target and showing whether the fixer is movable or unmovable (whether it is the fixer 303 or 304). The installation information is information showing whether or not the image forming apparatus 1 is in a state of having external option apparatuses such as a paper feeder unit 2 and a post-processing apparatus 3 shown in FIG. 2 installed therein and showing which of the option apparatuses is installed. When the option apparatus is installed to the image forming apparatus 1, the weight and installation area of the image forming apparatus 1 are changed, thereby influencing vibration of the operation displayer 30. The drive information is information showing the intensity of drive of the vibrator 33 and showing which vibration element is to be vibrated among three vibration elements of the vibrator 33. The drive information is set such that the intensity of vibration to be felt by the finger of the user on the operation display panel of the displayer 31 becomes uniform regardless of the model information of the image forming apparatus 1, the fixing-structure type information, and the installation information.

The communicator 13 is configured with a network card or the like, connected to a communication network such as LAN (Local Area network), and exchanges information with external devices on the communication network. The controller 11 communicates with the external devices on the communication network via the communicator 13.

The paper feeder 14 includes a plurality of feeder trays T1 that house sheets of various sizes and types, for example, and takes out the indicated type of sheet from the feeder tray T1 and conveys to the image former 18 under the control of the controller 11.

The image reader 15 includes an automatic document conveyor, a scanner, a placement tray, a platen glass, and the like. The automatic document conveyor includes a mechanism for conveying the placement tray on which the document sheet is placed and the document sheet, a conveyor roller, and the like, and conveys the document sheet on a prescribed conveyance path. The scanner includes an optical system such as a light source and a reflection mirror as well as an imaging element, reads out the image on the document sheet conveyed on the prescribed conveyance path or the image on the document sheet placed on the platen glass, and generates bitmap-format image data of each of colors R (red), G (green), and B (blue). The image reader 15 controls the automatic document conveyor, the scanner, and the like to read out the image of the document and generates the image data under the control of the controller 11.

The controller 11 performs rasterization on the PDL data received by the communicator 13 to generate the bitmap-format image data. Further, when the bitmap-format image data generated via the communicator 13 or the image reader 15 has pixel values of three colors of R (red), G (green), and B (blue), the controller 11 converts it to the image data having pixel values of four colors of C, M, Y, and K, and then saves the image data in the image memory 17.

The image memory 17 is a buffer memory that temporarily saves the image data generated by the image processor 16. As the image memory 17, it is possible to use a DRAM (Dynamic RAM) or the like.

The image processor 16 reads out the image data from the image memory 17 and performs various kinds of image processing such as density correction processing and halftone processing under the control of the controller 11. The density correction processing is processing that converts each pixel value of the image data such that the density property of the image on the sheet becomes the target density property. The halftone processing is processing that regenerates halftone in a pseudo manner, such as dither processing and error diffusion processing.

The image former 18 forms the image of four colors on the sheet according to the pixel values of the four colors C, M, Y, and K of each of the pixels of the image data on which image processing is performed by the image processor 16 under the control of the controller 11. The image former 18 includes four writing units, an intermediate transfer belt, and a secondary transfer roller (all not shown).

The four writing units are disposed tandem along the belt face of the intermediate transfer belt by each of the colors C, M, Y, and K as four plain colors, and forms image of each of the colors C, M, Y, and K on the sheet. The writing unit includes a photosensitive drum, a charger, an exposure device, a developer, a cleaner, and a primary transfer roller (all not shown).

The photosensitive drum is a rotary conductive cylinder. The charger charges the photosensitive drum under the control of the controller 11. The exposure device includes an LD (Laser Diode) as a light-emitting element, and drives the LD based on the image data to irradiate laser light on the photosensitive drum charged by the charger for exposure under the control of the controller 11. The developer supplies toner on the photosensitive drum by a charged developing roller and develops a latent image formed on the photosensitive drum by exposure under the control of the controller 11. By stacking the images formed in the manner described above on the photosensitive drums of the four writing units sequentially on the intermediate transfer belt and transferred by respective primary transfer rollers(primary transfer), a color toner image configured with each of the colors is formed on the intermediate transfer belt. After the primary transfer, the cleaner removes the toner remained on the photosensitive drum.

The intermediate transfer belt is an endless belt placed over a plurality of rollers, and rotates according to rotation of each of the rollers under the control of the controller 11. The secondary transfer roller 23 transfers (secondary transfer) the toner image formed on the intermediate transfer belt on the sheet conveyed from the paper feeder 14 (feeder tray T1) under the control of the controller 11.

The fixer 19 includes a heater and a pressure roller, for example, and fixes the toner image on the sheet by applying heat and pressure to the sheet on which the toner image is formed by the image former 18 under the control of the controller 11.

The sheet conveyor 20 includes a resist roller, a conveyance roller, and the like for conveying the sheet. The sheet conveyor 20 feeds the sheet housed in the feeder trays T1 to the image former 18 under the control of the controller 11, and discharges the sheet after completing fixation by the fixer 19 to the output tray T2. Further, the sheet conveyor 20 includes an inverter as an inversion path of the sheet and, when performing double-sided printing, inverts the sheet with the image fixed on the top surface thereof and feeds it again to the image former 18 under the control of the controller 11.

The fixing-structure detector 21 detects the fixing-structure type of the operation displayer 30 (fixed, tilt, or slide, and the fixer 303 or the fixer 304), and outputs the information of the detected fixing-structure type to the controller 11. For example, the fixer of the operation displayer 30 has unique projections corresponding to the fixing-structure types, and the fixing-structure detector 21 acquires the fixing-structure type information by detecting the projections by a mechanical sensor. Note that it is also possible to employ a configuration with which the fixing-structure type information of the operation displayer 30 is inputted in advance and stored in the storage 12 by the manufacturer at the time of manufacture of the image forming apparatus 1 and, after shipped from the factory, the fixing-structure detector 21 reads out the fixing-structure type information from the storage 12.

The model detector 22 detects the type (model) of the image forming apparatus 1, and outputs the detected model information of the image forming apparatus 1 to the controller 11. For example, the fixer of the operation displayer 30 has unique projections corresponding to the model of the image forming apparatus 1, and the model detector 22 acquires the model information by detecting the projections by the mechanical sensor. Note that it is also possible to employ a configuration with which the model information of the image forming apparatus 1 is stored in advance in the storage 12 by the manufacturer at the time of manufacture of the image forming apparatus 1 and, after shipped from the factory, the model detector 22 reads out the model information from the storage 12.

The paper feeder unit 2 as an option apparatus is connectable by being attached to the housing H1 of the image forming apparatus 1, and includes a plurality of large-capacity feeder trays that house sheets of various sizes and types, for example. The paper feeder unit 2 takes out the type of sheet indicated by the controller 11 from the feeder tray within the paper feeder unit 2, and conveys the sheet to the housing H1 of the image forming apparatus 1.

The post-processing apparatus 3 as an option apparatus is connectable by being attached to the housing H1 of the image forming apparatus 1, and includes a sheet conveyor, a post-processing apparatus, an and output tray (not shown). The sheet conveyor includes a conveyor roller and the like, conveys the sheet conveyed from the housing H1 of the image forming apparatus 1 to the post-processing apparatus, and conveys the sheet on which post-processing is performed by the post-processing apparatus to the output tray under the control of the controller 11. The post-processing apparatus performs the post-processing on the conveyed sheet under the control of the controller 11. Examples of the post-processing may be stapling processing, hole-punching processing, folding processing, and bookbinding processing.

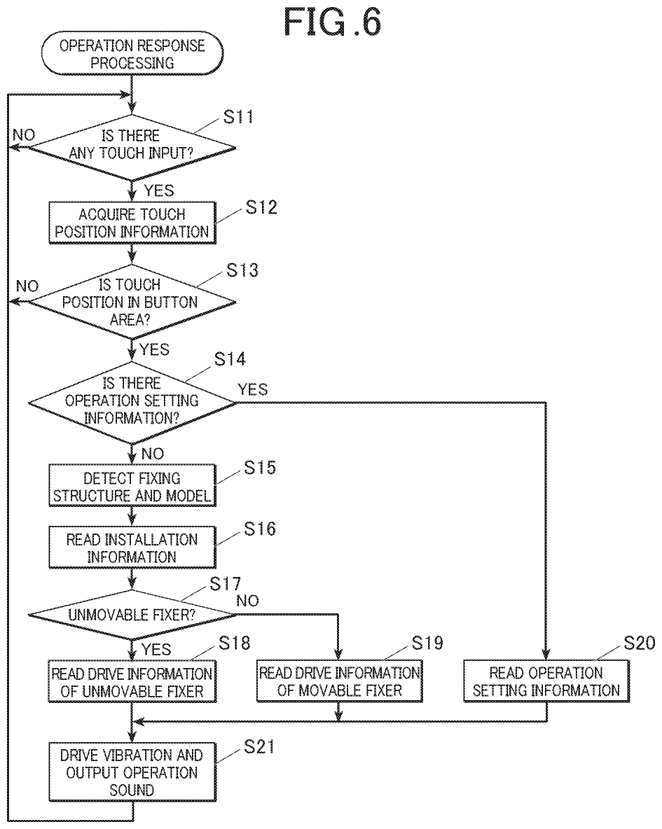

Next, by referring to FIG. 6, actions of the image forming apparatus 1 will be described. FIG. 6 is a flowchart showing operation response processing.

It is assumed that installation information showing whether or not any option apparatus is attached and which of the option apparatuses is attached to the image forming apparatus 1 is inputted in advance by a worker via the operation displayer 30, and stored in the storage 12 at the time of installing the image forming apparatus 1 at an installation place such as an office. Further, in a case where there is a change in the option apparatus to be attached to the image forming apparatus 1, the installation information after the change is inputted by the worker via the operation displayer 30 and the installation information stored in the storage 12 is changed.

Further, if there is input of the operation setting information including the intensity of vibration of the vibrator 33 and the direction of the vibration made by the user via the operation displayer 30 at any time during the power is on, the controller 11 receives the input of operation setting information and stores the operation setting information in the storage 12.

In the operation displayer 30 of the image forming apparatus 1, the operation screen for receiving each kind of operation input such as setting of the image forming apparatus 1 is displayed on the displayer 31 to receive input of various kinds of operations from the user via the operator 32.

In the image forming apparatus 1, the controller 11 executes operation response processing according to the operation response program stored in the storage 12 triggered by, for example, a start of reception of operation input (for example, triggered by display of the operation screen).

As shown in FIG. 6, first, the controller 11 determines whether or not there is push input made by a touch of the user via the operator 32 (step S11). As for the determination of reception of push on the touch panel via the operator 32 in step S11, there is a case where the reception is determined “on edge” that is when the finger of the user touches the panel and a case where the reception is determined “off edge” that is when the finger detaches therefrom. However, unlike the case of smartphones and the like that are operated by being held in a hand, the operator 32 determines the reception only “on edge” since it is necessary to give a vibration notification while the finger is touching for providing the vibration response notification.

If there is no push input by a touch (NO in step S11), the processing is shifted to step S11. If there is push input by a touch (YES in step S11), the controller 11 acquires information of the push input position made by a touch in step S11 (step S12).

Then, the controller 11 determines whether or not the information of the touch input position acquired in step S12 is a button area on the operation screen (step S13). If it is not the button area (NO in step S13), the processing is shifted to step S11. If it is the button area (YES in step S13), the controller 11 determines whether or not the operation setting information is stored in the storage 12 (step S14).

If the operation setting information is not stored (NO in step S14), the controller 11 detects the fixing-structure type of the operation displayer 30 by the fixing-structure detector 21 to acquire the fixing-structure type information, and detects the model of the image forming apparatus 1 by the model detector 22 to acquire the model information (step S15). Then, the controller 11 reads out the installation information of the image forming apparatus 1 from the storage 12 (step S16).

Then, the controller 11 determines whether or not the fixer of the operation displayer 30 is the unmovable fixer (fixer 303) from the fixing-structure type information acquired in step S16 (step S17). If it is the unmovable fixer (YES in step S17), the controller 11 refers to the drive information table stored in the storage 12, and acquires the drive information corresponding to the model information acquired in step S15, the fixing-structure type of the unmovable fixer acquired in step S15, and the installation information read out in step S16 (step S18). If it is not the unmovable fixer (NO in step S17), the controller refers to the drive information table stored in storage 12, and acquires the drive information corresponding to the model information acquired in step S15, the fixing-structure type of the movable fixer acquired in step S15, and the installation information read out in step S16 (step S19).

If the operation setting information is stored (YES in step S14), the controller 11 reads out the operation setting information from the storage 12 (step S20). Then, the controller 11 drives and vibrates the vibrator 33 by adjusting the intensity of the vibration and the direction of the vibration based on the drive information or the operation setting information acquired in step S18, step S19, or step S20 and outputs an operation sound by the sound outputter 34 (step S21), then shifts the processing to step S11. The vibration in step S21 is generally driven in short time.

As described above, the image forming apparatus 1 according to the embodiment includes: the operation display panel (movable component 301) that receives touch input; the operator 32 including the fixer 303 or 304 that fixes the operation display panel to the housing H1; the vibrator 33 that vibrates the operation display panel; the controller 11 that controls the vibrator 33 according to the drive information regarding the drive intensity to make the intensity of the vibration of the operation display panel uniform by corresponding to the fixer 303 or 304 when there is operation input made on the operator 32; the housing H1; and the image former 18 that forms the image on the sheet.

Therefore, even if the operation display panel of the operation displayer 30 is mounted (attached) to the housing H1 of the image forming apparatus 1 via the different fixer (fixer 303 or 304), the operation display panel can be vibrated uniformly regardless of the configuration of the image forming apparatus when the operation display panel is operated.

Further, the image forming apparatus 1 includes the fixing-structure detector 21 that detects and acquires the fixing structure of the fixer (fixer 303 or 304). The controller 11 controls the vibrator 33 according to the drive information corresponding to the acquired fixing structure. Therefore, it is possible to uniformly vibrate the operation display panel regardless of the fixing structure of the fixer of the operation displayer 30 of the image forming apparatus 1.

Further, the image forming apparatus 1 includes the model detector 22 that detects and acquires the model of the image forming apparatus. The controller 11 controls the vibrator 33 according to the drive information corresponding to the acquired model. Therefore, it is possible to uniformly vibrate the operation display panel regardless of the configuration of each model of the image forming apparatus 1.

Further, the controller 11 read out and acquires the installation information showing the installation state of the option apparatus with respect to the image forming apparatus 1 from the storage 12, and controls the vibrator 33 according to the drive information corresponding to the acquired installation information. Therefore, it is possible to uniformly vibrate the operation display panel regardless of the installation state of each option apparatus of the image forming apparatus 1.

Further, the vibrator 33 is capable of controlling the direction of vibration. The drive information includes the intensity of drive and the direction of vibration. The controller 11 controls the intensity of drive and the direction of vibration of the vibrator 33 according to the drive information. Therefore, it is possible to uniformly vibrate the operation display panel regardless of each of the movable directions of the operation display panel of the image forming apparatus 1.

Further, the image forming apparatus 1 includes the storage 12 that shores the drive information (drive information table). Therefore, the drive information can be easily acquired by reading it out from the storage 12.

Further, the operation display panel receives input of the drive information. The controller 11 controls the vibrator 33 according to the inputted drive information. Therefore, the user can uniformly vibrate the operation display panel manually regardless of the configuration of the image forming apparatus 1.

Further, the controller 11 performs on edge detection of operation input made on the operator 32 in the button area as the operation response area of the operation display panel. Therefore, it is possible to achieve operation response vibration suited for the image forming apparatus 1 that is not a mobile device.

The description in the embodiments above shows examples of the preferable operation vibration apparatus, image forming apparatus, and program according to the present invention, and it is not intended to be limited to those. For example, the installation target of the operation panel (operation display panel) of the operation vibration apparatus (operation displayer 30 or the like) may be other apparatuses and the like than the information forming apparatus.

Further, detailed configurations and detailed actions of each component configuring the image forming apparatus 1 according to the embodiments described above can be changed as appropriate without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An operation vibration apparatus, comprising:
an operator including an operation panel that receives touch input, and a fixer that fixes the operation panel to a housing as an installation target;
a vibrator that vibrates the operation panel; and
a hardware processor that controls the vibrator according to drive information regarding intensity of drive to make vibration of the operation panel uniform by corresponding to the fixer, when there is operation input made on the operator.

2. The operation vibration apparatus according to claim 1, comprising a fixing-structure acquirer that acquires a fixing structure of the fixer, wherein
the hardware processor controls the vibrator according to the drive information corresponding to the acquired fixing structure.

3. The operation vibration apparatus according to claim 1, comprising a model acquirer that acquires a model of the installation target, wherein
the hardware processor controls the vibrator according to the drive information corresponding to the acquired model.

4. The operation vibration apparatus according to claim 1, wherein
the hardware processor acquires installation information showing an installation state of an option apparatus to the installation target, and controls the vibrator according to the drive information corresponding to the acquired installation information.

5. The operation vibration apparatus according to claim 1, wherein:
the vibrator is capable of controlling a direction of vibration;
the drive information includes the direction of vibration; and
the hardware processor controls the intensity of drive and the direction of vibration of the vibrator according to the drive information.

6. The operation vibration apparatus according to claim 1, comprising a storage that stores the drive information.

7. The operation vibration apparatus according to claim 1, wherein:
the operator receives input of the drive information; and
the hardware processor controls the vibrator according to the inputted drive information.

8. The operation vibration apparatus according to claim 1, wherein the hardware processor performs on edge detection of operation input made on the operator in an operation response area of the operation panel.

9. An image forming apparatus, comprising:
the operation vibration apparatus according to claim 1;
the housing; and
an image former that forms an image on a sheet.

10. A non-transitory computer readable recording medium storing a program for causing a computer to function as:
an operator including an operation panel that receives touch input, and a fixer that fixes the operation panel to a housing as an installation target;
a vibrator that vibrates the operation panel; and
a hardware processor that controls the vibrator according to drive information regarding intensity of drive to make intensity of vibration of the operation panel uniform by corresponding to the fixer, when there is operation input made on the operator.
